(19) United States
(12) Patent Application Publication
(10) Pub. No.: US 2015/0268985 A1
(43) Pub. Date: Sep. 24, 2015

(54) Low Latency Data Delivery

(71) Applicant: Freescale Semiconductor, Inc., Austin, TX (US)

(72) Inventors: Tommi M. Jokinen, Austin, TX (US); Zheng Xu, Austin, TX (US); Kun Xu, Austin, TX (US)

(73) Assignee: FREESCALE SEMICONDUCTOR, INC., Austin, TX (US)

(21) Appl. No.: 14/223,252

(22) Filed: Mar. 24, 2014

(51) Int. Cl. G06F 9/46

(52) U.S. Cl. CPC G06F 9/46

(57) ABSTRACT

The present invention relates to apparatus and methods for low latency data delivery within multi-core processing systems. The apparatus and method comprises assigning a task to a processing core; identifying a job within the task to be performed via an accelerator; performing and completing the job via the accelerator; generating output data including associated status information via the accelerator, the status information including an associated inactive write strobe; snooping the status information to determine when the job being performed by the accelerator is completed, the snooping comprising snooping the status information; and continuing executing the task using the output data associated with the status information.

### BACKGROUND OF THE INVENTION

This disclosure relates generally to multi-core processing systems and more particularly to low latency data delivery within multi-core processing systems.

### DESCRIPTION OF THE RELATED ART

Multi-core processing systems often perform operations on packet data in which those operations are performed as tasks. Various cores executing a particular program perform tasks assigned to them by a task manager. The tasks themselves may have time periods in which another resource, such as a hardware accelerator, is performing a portion, or job, of the task so that the core is not actually involved with that task. In such case, the core can be used to execute another task while the job is being executed by the accelerator. When the hardware accelerator, for example, completes the job, the core eventually needs to continue the task. Thus it is important that the core be aware of the last known state of the task. This type of operation in which context information is used in providing for a core to switch tasks prior to completing the task is generally referenced as context switching. Context switching provides a benefit of more use of the cores in a given amount of time. However, one cost associated with context switching is that there can be some delay in transferring between jobs due to loading the context information of a previous task as it becomes the current task for the core. Also, there is a continuous desire for increased efficiency in performing tasks more quickly and with fewer resources.

In processing systems, such as Advanced I/O Processor (AIOP) processing systems, there are accelerator modules which are often provided input data from a workspace (such as a memory mapped random access memory (RAM)) workspace. After completing the job for which the input data was provided, output data is written back to the workspace. When the output data is written back to the workspace, a data consumer (such as a processor core) often needs to be notified that the output data has been written to the workspace. For reduced latency and increased performance, it is important that the data consumer be notified as early as possible of completion. A plurality of techniques is known to provide the notification. These techniques include providing a separate notification interface of completion, providing side band signals associated with an address/data bus, which are snooped by consumer and providing an additional status transaction after the output data is written to the workspace. However, these techniques can add additional routing and area to the processing system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a block diagram of a data processing system.

FIG. 2 shows a block diagram of a transaction format of information being communicated from an accelerator.

FIG. 3 shows a block diagram of the operation of the zero byte data beat within a data processing system.

FIG. 4 shows a flow chart of the operation of a low latency data delivery data processing system.

### DETAILED DESCRIPTION

In general, some embodiments of the present invention relate to a method comprising: assigning a task to a processing core; identifying a job within the task to be performed via an accelerator; performing and completing the job via the accelerator; generating output data including associated status information via the accelerator, the status information including an associated inactive write strobe; snooping the status information to determine when the job being performed by the accelerator is completed, the snooping comprising snooping the status information; and continuing executing the task using the output data associated with the status information.

More specifically in certain embodiments, the present invention relates to a method comprising: assigning a task to a processing core; identifying a job within the task to be performed via an accelerator; performing and completing the job via the accelerator; generating output data including associated status information via the accelerator, the status information including an associated inactive write strobe; snooping the status information to determine when the job being performed by the accelerator is completed, the snooping comprising snooping the status information; and continuing executing the task using the output data associated with the status information.

In other embodiments, the invention relates to a data processing system comprising: a processing core, the processing core performing a task; an accelerator, the processor core identifying a job to be performed by the accelerator; and, an interconnect circuit coupled to the processing core and the accelerator, the accelerator generating output data including associated status information, the status information including an associated inactive write strobe, the processing core snooping the status information to determine when the job being performed by the accelerator is completed, the snooping comprising snooping the status information and, the processing core continuing executing the task using the output data associated with the status information.

In other embodiments, the invention relates to an apparatus comprising an interconnect coupled to a processing core and an accelerator, the accelerator generating output data including associated status information, the status information including an associated inactive write strobe, the processing core snooping the status information to determine when the job being performed by the accelerator is completed, the snooping comprising snooping the status information and, the processing core continuing executing the task using the output data associated with the status information.

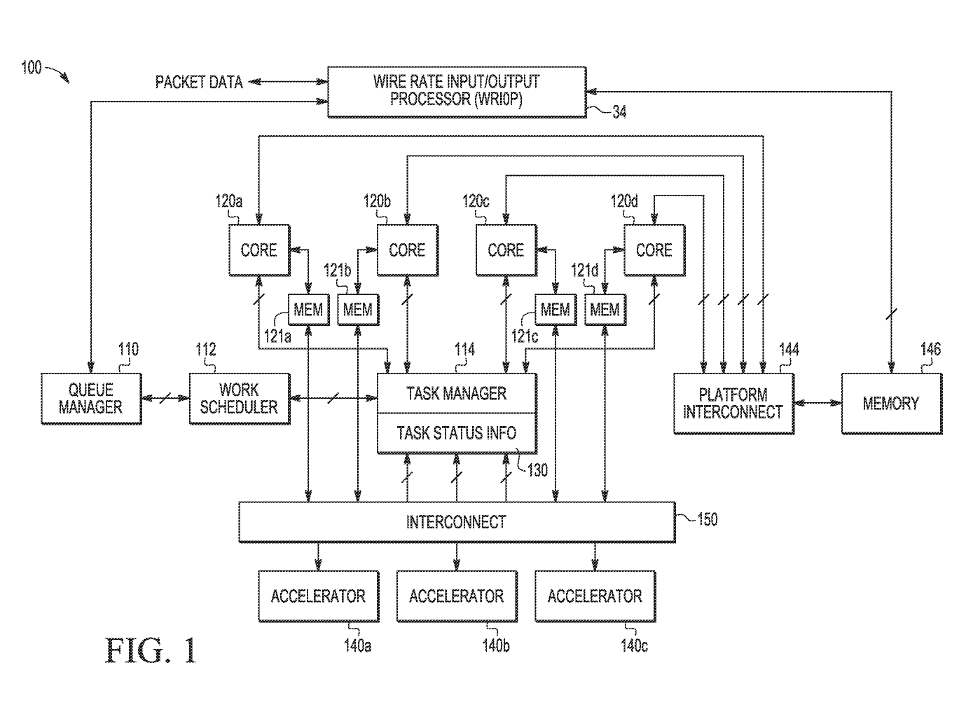

Referring to FIG. 1, a data processing system 100, such as an all in one processor data processing system, is shown. The data processing system 100 includes a queue manager 110, a work scheduler 112 coupled to the queue manager 110, a task manager 114 coupled to the work scheduler 112, at least one core 120 coupled to task manager 114, at least one accelerator 140 coupled to task manager 114, a platform interconnect 144 coupled to cores 120, a memory 146 coupled to platform interconnect 144, and an input/output processor (IOP) 142 coupled to memory 146. Each core 120 is also coupled to a respective workspace memory 121 which in certain embodiments comprises a respective random access memory. In various embodiments, the data processing system comprises any number of cores. The IOP 142 loads information into the memory 146 that is used by cores 120 executing a program. The cores 120 access the memory 146 through the platform interconnect 144 as needed to perform tasks. The IOP 142 also reads the memory 146 to obtain program results. The task manager 114, the workspace memory 121 and the accelerators 140 are all also coupled to an interconnect 150.

In certain embodiments, the interconnect 150 comprises an Advanced Microcontroller Bus Architecture (AMBA) Advanced eXtensible Interface (AXI) interconnect. The AMBA interconnect is an open standard, on-chip interconnect specification for connection and management of functional blocks. The AXI portion of the standard further defines the standard to include separate address/control and data phases, support unaligned data transfers using byte strobes, support burst based transitions with only start address issued, allows issuing of multiple outstanding addresses with out of order responses and allows the addition of register stages to provide timing closure.

Examples of accelerators 140 include direct memory access (DMA), table look-up (TLU), parse/classify/distribute (PCD), reassembly unit, security (SEC), work scheduler, and task termination. Included within the task manager 130 is a task status information module 130 which maintains the status of each task. For each task there is a core that is assigned to perform the task, a context ID, and a status. The status may be one of four possibilities as follows: ready, executing, inhibited, and invalid. Ready means that the task is waiting to be scheduled to core. Inhibited means the core is waiting for something else such as an accelerator to finish its job. Executing means the core is actively working on the task. Invalid means the task is not a valid task.

In operation, the queue manager 110 provides a frame descriptor to the work scheduler 112 that in turn defines a plurality of tasks to be performed under the direction of task manager 114. The task manager 114 assigns tasks to the cores 120. The cores 120 begin executing the assigned tasks which may include a first task assigned to one core 120a and other tasks assigned to other cores 120b, 120c, 120d. The first task may include a job that is a software operation that the core 120a may perform on its own, The first task may also include a job that makes use of an accelerator such as accelerator 140a. In such case, the core 120a requests use of an accelerator from the task manger 114 and stores the context information for that stage of the task in a context storage buffer in the core 120a. The task manager 114 passes that job to an accelerator 140a that can perform the job. If the accelerator 140a can perform the job, the task manager 114 may assign the job to the accelerator 140a. After the task manager 114 assigns the job to the accelerator 140a, the core 120a is then available for the task manger 114 to assign it a second task. While the accelerator 140a is executing the job it has been assigned, the core 120a may begin the second task or it may be inhibited as it waits for the accelerator 140a to complete the job. When the accelerator 140a finishes its assigned job, the accelerator 140a provides an output pointer and completion status information to the task manager 114. The core 120a may still be performing the second task if it was not inhibited. Another core, such as core 120b, may be available for performing tasks at this point. In such case, the task manager 114 fetches the context information from the first core 120a and assigns the first task to another core 120b while also providing the context information to the other core 120b. With the core 120b now having the context information, the core 120b can continue with the first task. When a context is switched to a different core, task status information 130 is updated indicating that the other core 120b is now assigned to the first task. Also the executing of the task by the other core 120b will be entered in task status information 130.

When the task manager 114 accesses the context information from a core to move a task from one core to another core, the task manager 114 also receives other information relative to the task that is to be continued. For example, if an accelerator 140 is to be used next in executing the task, additional information beyond the context information that would be passed from the core to task manager 114 include identification of the particular type of accelerator, additional information, if any, about the attributes of the accelerator, inband information, if any, that would be passed to the accelerators as output pointers or command attributes, and input/output pointers.

Thus it is seen that packet data is processed in the form of tasks in which context switching is not just implemented for a single core but is able to switch context information from one core to another to provide more efficient execution of the tasks. In effect when the task manager 114 detects that the situation is right to transfer context from one core to another, the task manager 114 migrates tasks in ready state between cores without the cores knowledge. A core 120 may not have information about other cores or tasks in the system and in such case cannot initiate the migration. The task manager 114 accesses the context information from one core and transfers it to a second core which then executes the task. Thus, the task manager 114 may be viewed as migrating execution of a task from one core to another that includes transferring the context information.

When a packet data is received, the IOP 142 provides the frame information to the queue manager 110 and loads the data in memory 146. The packet data is processed through the cores 120 that access the memory 146 as needed. When a packet data is output by IOP 142, the data is read from the memory 146 and formatted using frame information provided by the queue manager 110.

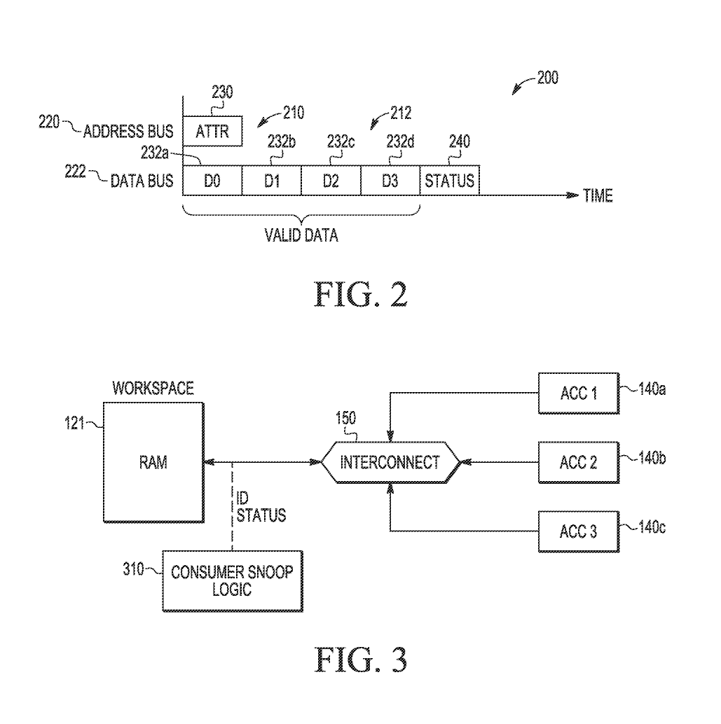

Referring to FIG. 2, a block diagram of a transaction format of information being communicated from an accelerator is shown. More specifically, when an accelerator 140 completes a task, the accelerator 140 generates output data 200. The output data includes address information 210 as well as data information 212. In certain embodiments, the address information 210 is provided to an address bus 220 and the data information 212 is provided to a data bus 222. The address information includes a byte of attribute information 230. In various embodiments, the attribute information may include a number of beats, a beat size, cache attributes and protection attributes. The data information includes a plurality of bytes of data 232 (e.g., D0, D1, D2, D3). Each byte of data is identified by setting a corresponding data byte write strobe active (e.g., by setting a data byte strobe high). In certain embodiments, the combination of the byte of data and the data byte write strobe may be considered at data “beat”.

The data information further includes at least one byte of status information 240, The byte of status information 240 is identified by setting a corresponding data byte write strobe inactive (e.g., by setting the data byte strobe low). This byte of status information 240 may be considered a “zero-byte” data beat. By providing the output data associated with the accelerator with a zero-byte data beat, the data processing system 100 uses an existing capability of certain interconnect protocols (albeit in a new capacity) without adding additional area to indicate when an accelerator completes a task. Additionally, by providing the output data associated with the accelerator with a zero-byte data beat, a near instantaneous notification of task completion is provided to a snooping consumer when data has been written to the workspace 121 (i.e., when the task completes execution by the accelerator 140). The amount of information that can be passed via the interconnect 150 using zero-byte data beats is not limited.

Referring to FIG. 3, a block diagram of the operation of the zero byte data beat within the data processing system 100 is shown. More specifically, the data processing system uses the interconnect 150 to read and write data to the workspace 121 (i.e., the memory associated with the core 120 for which the accelerator task is being performed). The interconnect 150 uses write-strobes to indicate to the target which bytes of data are valid and are to be written. Additionally, the interconnect 150 is configured so that it does not optimize away or add zero-byte data beats. When the write strobes are inactive (e.g., set low), any data that is transmitted via the interconnect 150 is ignored by the target (e.g., the core 120 for which the accelerator task is being performed). Each core 120 also includes respective snoop logic 310. The snoop logic 310 snoops when data has been written to the workspace 121 (i.e., when the task completes execution by the accelerator 140) of the respective core thus providing a near instantaneous notification of task completion.

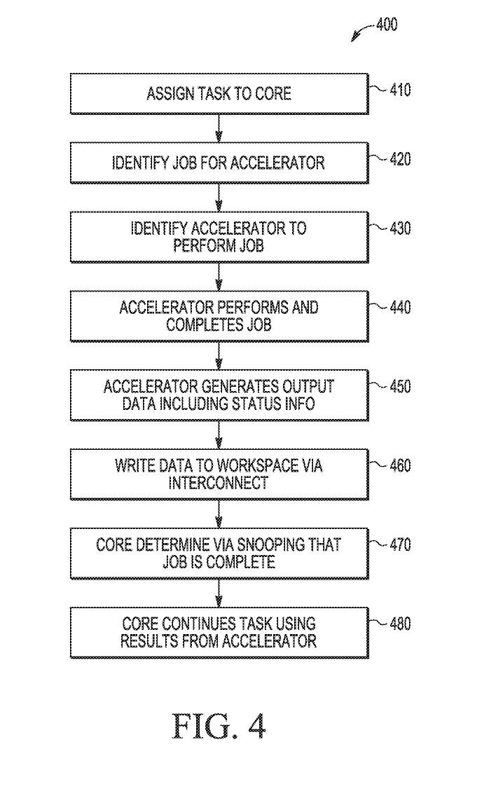

Referring to FIG. 4, a flow chart of the operation 100 of a low latency data delivery data processing system 100 is shown. More specifically, the low latency data delivery operation begins with a task being assigned to a core 120 at step 410. Next at step 420, the core determines that a job of the task can be completed via an accelerator 140. Next, at step 430, the task manager 114 identifies an accelerator 140 for performing the job. Next at step 440, the accelerator 140 performs and completes the job. The accelerator 140 generates output data including status information at step 450. Next at step 460, the data is written to the workspace 121 via the interconnect 150. During step 470, the core that is awaiting the output data snoops the workspace 121 via the snoop circuit 310 and determines that the job is complete based upon the zero byte data beat status information. Next, at step 480, the core continues the executing the task using the output data stored in the workspace 121 from the accelerator 140.

Although the invention is described herein with reference to specific embodiments, various modifications and changes can be made without departing from the scope of the present invention as set forth in the claims below. For example, a different resources than accelerators may be used by the cores in accomplishing tasks. Also for example, while the example shows adjacent data bytes with a status byte as the last byte of the output data, it will be appreciated that the bytes need not necessarily be adjacent and also that the status byte need not be the last byte of the output data.

Accordingly, the specification and figures are to be regarded in an illustrative rather than a restrictive sense, and all such modifications are intended to he included within the scope of the present invention. Any benefits, advantages, or solutions to problems that are described herein with regard to specific embodiments are not intended to be construed as a critical, required, or essential feature or element of any or all the claims.

Consequently, the invention is intended to be limited only by the spirit and scope of the appended claims, giving full cognizance to equivalents in all respects.

What is claimed is:

1. A method comprising:
assigning a task to a processing core;
identifying a job within the task to be performed via an accelerator;
performing and completing the job via the accelerator;
generating output data including associated status information via the accelerator, the status information including an associated inactive write strobe that indicates whether the task has completed, the associated inactive write strobe identifying the status information within the output data;
snooping the status information to determine when the job being performed by the accelerator is completed, the snooping comprising snooping the status information; and
continuing executing the task using the output data associated with the status information.

2. The method of claim 1 further comprising:
providing the output data including the associated status information to a workspace associated with the processing core, the providing via an interconnect circuit.

3. The method of claim 2 wherein:
the interconnect circuit comprises separate address and data phases; and,
the associated status information is provided via the data phase of the interconnect circuit.

4. The method of claim 2 wherein:
the interconnect circuit comprises an Advanced Microcontroller Bus Architecture (AMBA) interconnect.

5. The method of claim 4 wherein:
the Advanced Microcontroller Bus Architecture (AMBA) interconnect further comprises an Advanced eXtensible Interface (AXI) interconnect.

6. A data processing system comprising:
a processing core, the processing core performing a task;
an accelerator, the processor core identifying a job to be performed by the accelerator;
an interconnect circuit coupled to the processing core and the accelerator, the accelerator generating output data including associated status information, the status information including an associated inactive write strobe that indicates whether the task has completed, the associated inactive write strobe identifying the status information within the output data, the processing core snooping the status information to determine when the job being performed by the accelerator is completed, the snooping comprising snooping the status information and, the processing core continuing executing the task using the output data associated with the status information.

7. The data processing system of claim 6 further comprising:
a workspace associated with the processing core; and wherein
the output data including the associated status information is provided to the workspace associated with the processing core via the interconnect circuit.

8. The data processing system of claim 7 wherein:
the interconnect circuit comprises separate address and data phases; and,
the associated status information is provided via the data phase of the interconnect circuit.

9. The data processing system of claim 7 wherein:
the interconnect circuit comprises an Advanced Microcontroller Bus Architecture (AMBA) interconnect.

10. The data processing system of claim 9 wherein:
the Advanced Microcontroller Bus Architecture (AMBA) interconnect further comprises an Advanced eXtensible Interface (AXI) interconnect.

11. An apparatus comprising:
an interconnect coupled to a processing core and an accelerator, the accelerator generating output data including associated status information, the status information including an associated inactive write strobe that indicates whether the task has completed, the associated inactive write strobe identifying the status information within the output data, the processing core snooping the status information to determine when the job being performed by the accelerator is completed, the snooping comprising snooping the status information and, the processing core continuing executing the task using the output data associated with the status information.

12. The apparatus of claim 11 further comprising:
a workspace associated with the processing core; and wherein
the output data including the associated status information is provided to the workspace associated with the processing core via the interconnect circuit.

13. The apparatus of claim 12 wherein:
the interconnect circuit comprises separate address and data phases; and,
the associated status information is provided via the data phase of the interconnect circuit.

14. The apparatus of claim 12 wherein:
the interconnect circuit comprises an Advanced Microcontroller Bus Architecture (AM BA) interconnect.

15. The apparatus of claim 14 wherein:
the Advanced Microcontroller Bus Architecture (AMBA) interconnect further comprises an Advanced eXtensible Interface (AXI) interconnect.
